(19) United States
(12) Patent Application Publication
(10) Pub. No.: US 2025/0256488 A1
(43) Pub. Date: Aug. 14, 2025

(54) HIGH-STRENGTH LAMINATED GLASS BASED ON INTERLAYER MEMBRANE AND PREPARATION METHOD THEREOF

(71) Applicant: Dongguan Qunan Plastic Industrial Co. Ltd, Dongguan (CN)

(72) Inventors: Xiaofeng Yan, Dongguan (CN); Jianqun Feng, Yongchun (CN)

(21) Appl. No.: 19/194,556

(22) Filed: Apr. 30, 2025

(30) Foreign Application Priority Data
Aug. 15, 2024 (CN) 202411119348.2

(51) Int. Cl. B32B 17/10

(52) U.S. Cl. CPC B32B 17/1077; B32B 17/10036; B32B 17/10678; B32B 17/10816; B32B 2250/03; B32B 2250/40; B32B 2307/7376

(57) ABSTRACT

A high-strength laminated glass based on an interlayer membrane and a preparation method thereof are provided, which relate to the technical field of laminated glass. The preparation method of the high-strength laminated glass based on the interlayer membrane comprises: Step 1: successively adding polytetrahydrofuran ether glycol and an reactive anti-UV agent into N,N-dimethylformamide, successively adding diisocyanate and an organotin catalyst under the atmosphere of nitrogen, heating to 80-85° C. to react for 2-3 h, performing vacuum de-bubbling; Step 2: soaking the interlayer membrane in toluene for 6-10 h, transferring the soaked interlayer membrane to methanol to be soaked for 2-4 h, and drying for 3-5 days at room temperature to obtain a modified interlayer membrane; and Step 3: placing the modified interlayer membrane in the middle of two layers of glass, and then performing hot press compound to obtain the high-strength laminated glass.

### TECHNICAL FIELD

The present disclosure relates to the technical field of laminated glass, and particularly to a high-strength laminated glass based on an interlayer membrane and a preparation method thereof.

### BACKGROUND

Laminated glass (safety glass) is a composite glass product obtained by pressing a polymer interlayer membrane and glass arranged on both sides of the interlayer membrane at a high temperature, which is widely applied to various fields such as buildings and traffic. In the laminated glass, the polymer interlayer membrane plays an important and decisive role. At present, the laminated glass generally uses polyvinyl butyral as the interlayer membrane, however, although polyvinyl butyral has the advantages of good transparency, adhesion and the like, its water absorption will lead to the reduction in safety of the laminated glass, and its impact resistance is generally not enough to withstand strong external impacts.

Polyurethane is also a polymer having transparency, adhesion and controllability, which is expected to become a potential material for the interlayer membrane. If polyurethane is used as the interlayer membrane, it still has the advantages of transparency, high and low temperature resistance and the like, but its tensile strength and adhesion still need to be further improved, thereby improving its applicability in the laminated glass and then enhancing the impact resistance and adhesive property of the laminated glass. On the other hand, since safety glass is typically applied to curtain walls or windshields, it is needed to further improve its UV resistance. However, the introduction of an anti-UV agent typically has the problems of compatibility and migration, leading to the reduction in transparency, adhesion and other properties of an interlayer, thus affecting the performance of the laminated glass.

In conclusion, it is of great significance to prepare a high-strength laminated glass based on an interlayer membrane by using polyurethane as a main material of the interlayer membrane.

### SUMMARY

The objective of the present disclosure is to provide a high-strength laminated glass based on an interlayer membrane and a preparation method thereof, in order to solve the problems proposed in the background.

In order to solve the above technical problems, the present disclosure provides the following technical solution:

Provided is a preparation method of a high-strength laminated glass based on an interlayer membrane, comprising the following steps:

Step 1: successively adding polytetrahydrofuran ether glycol and an reactive anti-UV agent into N,N-dimethylformamide, successively adding diisocyanate and an organotin catalyst under the atmosphere of nitrogen, heating to 80-85° C. to react for 2-3 h, performing vacuum de-bubbling, adding a starch dispersing liquid containing starch nanoparticles, stirring for 20-30 min under the UV irradiation, adding a chain extender and a reactive dye, stirring for 20-30 min, pouring the obtained mixture into a mold, curing for 1.5-2.5 days at 75-85° C., and performing standing for 4-6 days at room temperature to obtain the interlayer membrane;

Step 2: soaking the interlayer membrane in toluene for 6-10 h, transferring the soaked interlayer membrane to methanol to be soaked for 2-4 h, and drying for 3-5 days at room temperature to obtain a modified interlayer membrane; and

Step 3: placing the modified interlayer membrane in the middle of two layers of glass, and then performing hot press compound to obtain the high-strength laminated glass.

Preferably, the raw materials of the interlayer membrane comprise the following components in parts by weight: 18-22 parts of polytetrahydrofuran ether glycol, 2-3 parts of reactive anti-UV agent, 11-13 parts of diisocyanate, 0.5-1 part of organotin catalyst, 1-1.5 parts of starch nanoparticles, 1-2 parts of chain extender and 0.5-1 part of reactive dye.

Preferably, a method for preparing the reactive anti-UV agent comprises the steps of: (1) evenly stirring citric acid, cysteine and deionized water for 2-2.5 h at 75-80° C., transferring the obtained mixture to a blast oven to be dried for 10-12 h at 130-140° C. to obtain pyridone diacid; (2) evenly mixing and stirring pyridone diacid, epichlorohydrin and tetrabutylammonium bromide for 20-30 min at 80-85° C., cooling to 45-50° C., dropwise adding a sodium hydroxide solution, stirring for 20-30 min, heating to 52-55° C. and stirring for 4-6 h to obtain dicyclooxopyridone; and (3) successively adding dicyclooxopyridone and 2-(ethenoxy) ethylamine into toluene to react for 6-8 h at 60-65° C., and then distilling to remove toluene to obtain the reactive anti-UV agent.

Preferably, a mass ratio of the citric acid to the cysteine to the deionized water is 19: (12-15):(10-20); a mass ratio of the pyridone diacid to the epichlorohydrin is 3:(20-22); and a molecular weight ratio of the dicyclooxopyridone to the 2-(ethyleneoxy) ethylamine is 4:(2.8-3).

Preferably, the starch dispersing liquid comprises the following raw materials: 1-1.5wt % of starch nanoparticles, 0.05-0.08wt % of photoinitiator and the balance of N,N-dimethylformamide.

Preferably, a method for preparing the starch nanoparticles comprises: (1) evenly mixing thioglycolic acid, acetic anhydride and corn starch, adding sulfuric acid, stirring and reacting for 12-16 h at room temperature, washing and drying to obtain thiolated starch; (2) successively dispersing corn starch and thiolated starch that are in mass ratio of 4:1 into the deionized water to obtain a solution with a solid content of 5-6wt %, stirring the above solution for 1-1.5 h at 90-92° C., performing ultrasonic treatment on the solution for 10-15 min under the power of 550-600 W, centrifuging and sucking supernatant; and (3) performing ultrasonic treatment on the supernatant in an ice bath under the power of 550-600 W, transferring the supernatant subjected to ultrasonic treatment to absolute ethyl alcohol at the rate of 2-5 mL/min, centrifuging and drying to obtain the starch nanoparticles.

Preferably, the chain extender comprises 1,4-butanediol and 2,6-pyridine dimethyl alcohol in a mass ratio of 3:2.

Preferably, the process condition for the UV irradiation is as follows: the light irradiance is 20-50 mW/cm².

Preferably, the temperature of the hot press compound is 120-140° C., the pressure of the hot press compound is 0.4-0.6 Mpa, and the time of the hot press compound is 3-8 min.

Preferably, in the high-strength laminated glass prepared by using the preparation method of the high-strength laminated glass based on the interlayer membrane, the thickness of the interlayer membrane is 0.2±0.05 mm.

Compared with the prior art, the present application has the beneficial effects: in the solution, a cross-linking network of polyurethane in the interlayer membrane is effectively regulated and controlled by introducing the reactive anti-UV agent and the starch nanoparticles and defining the chain extender, thereby effectively enhancing the tensile strength, adhesion and anti-UV irradiation of the interlayer membrane on the basis of ensuring the transparency of greater than 80% and then improving the comprehensive performance of the laminated glass.

(1) Pyridone diacid is prepared by reacting citric acid with cysteine, a heterocycle contained in the pyridone diacid has UV resistance; to introduced compatibility and limitation of small molecule migration; in the solution, a carboxyl group reacts with chlorine so that an epoxy group is grafted on pyridone diacid; then 2-(ethenoxy) ethylamine is grafted by utilizing the reaction of the epoxy group with an amino group so as to obtain the reactive anti-UV agent; wherein the epoxy group and the amino group are subjected to ring opening to generate a hydroxyl group which can act as diol to be grafted and blocked in polyurethane, so that the tensile strength and UV resistance of polyurethane are improved due to the presence of the heterocycle, thereby effectively enhancing the dispersibility of the anti-UV agent in the interlayer membrane layer and suppressing negative effects. On the other hand, the grafted 2-(ethenoxy) ethylamine contains an allyl group, which contributes to the dispersibility of the subsequent starch nanoparticles in the interlayer membrane, thereby effectively enhancing the UV resistance and impact resistance of the laminated glass. In addition, in the solution, 2,6-pyridine dimethyl alcohol containing a pyridine group is further introduced in the subsequent chain extender, thereby further improving the comprehensive performance.

(2) In the solution, the starch nanoparticles are introduced, the rest polyurethane has intermolecular interaction and therefore can act as a reinforcing phase to improve the strength and viscosity of the polyurethane interlayer membrane, thereby improving the impact resistance of the laminated glass; the introduction of the starch nanoparticles increases the hydrogen bonding degree of the polyurethane interlayer membrane and enhances the stretch resistance; the ally group in the reactive anti-UV agent in polyurethane is utilized to be grafted on the starch nanoparticles, increasing the orderliness of the starch nanoparticles in the cross-linking network of the polyurethane interlayer membrane to form an ordered microphase separation structure, thereby increasing the mechanical properties on the basis of ensuring the transmittance of greater than 80%.

(3) Since the introduction amounts of the reactive anti-UV agent and the starch nanoparticles should not be excess, excess introduction amounts are not beneficial for mechanical properties; therefore, in the solution, a solvent is further used to modify the interlayer membrane, the surface of the interlayer membrane is immersed with the solvent so that the interlayer membrane is expanded, the space and activity in a molecule chain are increased, and hydrogen bonds are rearranged, so as to form disordered hydrogen bonds; and then the solvent is evaporated to form disordered hydrogen bonds; and hot press is conducted in the middle of two layers of glass so that both adhesion and mechanical properties increase, thereby further improving the impact resistance of the laminated glass.

(4) In addition, the reactive dye is also introduced in the interlayer membrane. The reactive dye is generally a Yata polymer reactive dye which has multiple hydroxyl groups to react with isocyanate, thereby increasing the colors of the laminated glass and further increasing the beauty of the laminated glass.

### DETAILED DESCRIPTION OF THE EMBODIMENTS

Next, the technical solution in embodiments of the present disclosure will be clearly and completely described, obviously, the described embodiments are merely some embodiments of the present disclosure, but not all the embodiments. Based on the embodiments of the present disclosure, other embodiments obtained by a person of ordinary skill in the art without creative efforts are all included within the scope of protection of the present disclosure.

It is noted that parts in specific embodiments are mass parts; without any special restriction, the purchasing manufacturers of raw materials involved in the present disclosure exemplarily include: in the following examples, the model of the reactive dye is EVERTINT Red R-01, and the brand is Taiwan Yongguang; the purity of corn starch is 98%, the model is KA741214, and the brand is Jieshikai; the model of polytetrafluoroethylene ether glycol is PTMEG650, the model of an organotin catalyst is T-9, the CAS number of isophorone diisocyanate is 16672-87-0, the CAS number of 1,4-butanediol is 110-63-4, and the CAS number of 2,6-pyridine dimethyl alcohol is 1195-59-1, all of which are commercially available.

A method for preparing the reactive anti-UV agent comprises: (1) evenly stirring 19 parts of citric acid, 12.5 parts of cysteine and 15 parts of deionized water for 2 h at 80° C., transferring the obtained mixture to a blast oven to be dried for 12 h at 140° C. to obtain pyridone diacid; (2) evenly mixing and stirring 30 parts of pyridone diacid, 200 parts of epichlorohydrin and 1.7 parts of tetrabutylammonium bromide for 30 min at 80° C., cooling to 50° C., dropwise adding 5 parts of 10wt % sodium hydroxide solution, stirring for 30 min, heating to 55° C. and stirring for 6 h to obtain dicyclooxopyridone; and (3) successively adding 40 parts of dicyclooxopyridone and 28 parts of 2-(ethenoxy)ethylamine into 200 parts of toluene, reacting for 8 h at 60° C., and then distilling to remove toluene to obtain the reactive anti-UV agent.

A method for preparing the starch nanoparticles comprises: (1) evenly mixing 10 parts of thioglycolic acid, 4.2 parts of acetic anhydride and 2 parts of corn starch, adding 0.1 part of sulfuric acid, stirring and reacting for 12 h at room temperature, discarding supernatant, washing with ethyl alcohol and drying in vacuum at 40° C. to obtain thiolated starch; (2) successively dispersing corn starch and thiolated starch that are in mass ratio of 4:1 into the deionized water to obtain a solution with a solid content of 5wt %, stirring the solution for 1 h at 90° C., performing ultrasonic treatment on the solution for 10 min under the power of 600 W, centrifuging and sucking supernatant; and (3) performing ultrasonic treatment on the supernatant in an ice bath under the power of 600 W, transferring the supernatant subjected to ultrasonic treatment to 100 parts of absolute ethyl alcohol at the rate of 5 mL/min, centrifuging, rinsing a precipitate with cold water, and performing freeze drying on the rinsed precipitate to obtain the starch nanoparticles.

Example 1: A preparation method of a high-strength laminated glass based on an interlayer membrane comprises the following steps:

Step 1: 20 parts of polytetrahydrofuran ether glycol and 2 parts of reactive anti-UV agent were successively added into N,N-dimethylformamide, 12 parts of diisocyanate and 0.8 part of organotin catalyst were successively added under the atmosphere of nitrogen, the obtained mixture was heated to 85° C. to react for 2 h, vacuum de-bubbling was performed on the above reaction product, a starch dispersing liquid containing 1.2 parts of starch nanoparticles (1.2wt % starch nanoparticles, 0.05wt % of photoinitiator benzoin dimethyl ether and the balance of N,N-dimethylformamide) was added into the product subjected to vacuum de-bubbling, the above materials were stirred for 20 min in light illumination under an UV lamp with a light irradiance of 40 mA/cm², 1.8 parts of chain extender (1,4-butanediol and 2,6-pyridine dimethyl alcohol in a mass ratio of 3:2) and 0.5 part of reactive dye were added into the stirred material to be stirred for 20 min, the obtained mixture was poured into a mold and cured for 2 days at 80° C., and the cured product was subjected to standing for 5 days at room temperature to obtain a 0.2 mm interlayer membrane;

Step 2: the interlayer membrane was soaked in toluene for 8 h, the soaked interlayer membrane was transferred to methanol to be soaked for 4 h, and dried for 4 days at room temperature to obtain a modified interlayer membrane; and

Step 3: the modified interlayer membrane was placed in the middle of two layers of glass to perform hot press compound for 5 min at the temperature of 140° C. under the pressure of 0.5 Mpa to obtain the high-strength laminated glass.

Example 2: A preparation method of a high-strength laminated glass based on an interlayer membrane comprises the following steps:

Step 1:18 parts of polytetrahydrofuran ether glycol and 2 parts of reactive anti-UV agent were successively added into N,N-dimethylformamide, 11 parts of diisocyanate and 0.5 part of organotin catalyst were successively added under the atmosphere of nitrogen, the obtained mixture was heated to 85° C. to react for 2 h, vacuum de-bubbling was performed on the above reaction product, a starch dispersing liquid containing 1.5 parts of starch nanoparticles (1.5wt % starch nanoparticles, 0.05wt % of photoinitiator benzoin dimethyl ether and the balance of N,N-dimethylformamide) was added into the product subjected to vacuum de-bubbling, the above materials were stirred for 20 min in light illumination under an UV lamp with a light irradiance of 40 mA/cm², 2 parts of chain extender (1,4-butanediol and 2,6-pyridine dimethyl alcohol in a mass ratio of 3:2) and 0.5 part of reactive dye were added into the stirred material to be stirred for 20 min, the obtained mixture was poured into a mold and cured for 2 days at 80° C., and the cured product was subjected to standing for 5 days at room temperature to obtain a 0.2 mm interlayer membrane;

Step 2: the interlayer membrane was soaked in toluene for 10 h, the soaked interlayer membrane was transferred to methanol to be soaked for 2 h, and dried for 5 days at room temperature to obtain a modified interlayer membrane; and

Step 3: the modified interlayer membrane was placed in the middle of two layers of glass to perform hot press compound for 5 min at the temperature of 140° C. under the pressure of 0.5 Mpa to obtain the high-strength laminated glass.

Example 3: A preparation method of a high-strength laminated glass based on an interlayer membrane comprises the following steps:

Step 1:22 parts of polytetrahydrofuran ether glycol and 3 parts of reactive anti-UV agent were successively added into N,N-dimethylformamide, 13 parts of diisocyanate and 1 part of organotin catalyst were successively added under the atmosphere of nitrogen, the obtained mixture was heated to 85° C. to react for 2 h, vacuum de-bubbling was performed on the above reaction product, a starch dispersing liquid containing 1 part of starch nanoparticles (1wt % starch nanoparticles, 0.05wt % of photoinitiator benzoin dimethyl ether and the balance of N,N-dimethylformamide) was added into the product subjected to vacuum de-bubbling, the above materials were stirred for 20 min in light illumination under an UV lamp with a light irradiance of 40 mA/cm², 1 part of chain extender (1,4-butanediol and 2,6-pyridine dimethyl alcohol in a mass ratio of 3:2) and 0.5 part of reactive dye were added into the stirred material to be stirred for 20 min, the obtained mixture was poured into a mold and cured for 2 days at 80° C., and the cured product was subjected to standing for 5 days at room temperature to obtain a 0.2 mm interlayer membrane;

Step 2: the interlayer membrane was soaked in toluene for 6 h, the soaked interlayer membrane was transferred to methanol to be soaked for 4 h, and dried for 4 days at room temperature to obtain a modified interlayer membrane; and

Step 3: the modified interlayer membrane was placed in the middle of two layers of glass to perform hot press compound for 5 min at the temperature of 140° C. under the pressure of 0.5 Mpa to obtain the high-strength laminated glass.

Comparative example 1: A preparation method of a laminated glass based on an interlayer membrane. In this comparative example, a reactive anti-UV agent was not introduced; the rest is the same as that in Example 1; the preparation method of the laminated glass based on the interlayer membrane specifically comprises the following steps:

Step 1: 22 parts of polytetrahydrofuran ether glycol was successively added into N,N-dimethylformamide, 12 parts of diisocyanate and 0.8 part of organotin catalyst were successively added under the atmosphere of nitrogen, the obtained mixture was heated to 85° C. to react for 2 h, vacuum de-bubbling was performed on the above reaction product, a starch dispersing liquid containing 1.2 parts of starch nanoparticles (1.2wt % starch nanoparticles, 0.05wt % of photoinitiator benzoin dimethyl ether and the balance of N,N-dimethylformamide) was added into the product subjected to vacuum de-bubbling, the above materials were stirred for 20 min in light illumination under an UV lamp with a light irradiance of 40 mA/cm², 1.8 parts of chain extender (1,4-butanediol and 2,6-pyridine dimethyl alcohol in a mass ratio of 3:2) and 0.5 part of reactive dye were added into the stirred material to be stirred for 20 min, the obtained mixture was poured into a mold and cured for 2 days at 80° C., and the cured product was subjected to standing for 5 days at room temperature to obtain a 0.2 mm interlayer membrane;

Step 2: the interlayer membrane was soaked in toluene for 8 h, the soaked interlayer membrane was transferred to methanol to be soaked for 4 h, and dried for 4 days at room temperature to obtain a modified interlayer membrane; and

Step 3: the modified interlayer membrane was placed in the middle of two layers of glass to perform hot press compound for 5 min at the temperature of 140° C. under the pressure of 0.5 Mpa to obtain the high-strength laminated glass.

Comparative example 2: A preparation method of a laminated glass based on an interlayer membrane. In this comparative example, 2,6-pyridine dimethyl alcohol was used for replacing a reactive anti-UV agent; the preparation method of the laminated glass based on the interlayer membrane specifically comprises the following steps:

Step 1:20 parts of polytetrahydrofuran ether glycol and 2 parts of 2,6-pyridine dimethyl alcohol were successively added into N,N-dimethylformamide, 12 parts of diisocyanate and 0.8 part of organotin catalyst were successively added under the atmosphere of nitrogen, the obtained mixture was heated to 85° C. to react for 2 h, vacuum de-bubbling was performed on the above reaction product, a starch dispersing liquid containing 1.2 parts of starch nanoparticles (1.2wt % starch nanoparticles, 0.05wt % of photoinitiator benzoin dimethyl ether and the balance of N,N-dimethylformamide) was added into the product subjected to vacuum de-bubbling, the above materials were stirred for 20 min in light illumination under an UV lamp with a light irradiance of 40 mA/cm², 1.8 parts of chain extender (1,4-butanediol and 2,6-pyridine dimethyl alcohol in a mass ratio of 3:2) and 0.5 part of reactive dye were added into the stirred material to be stirred for 20 min, the obtained mixture was poured into a mold and cured for 2 days at 80° C., and the cured product was subjected to standing for 5 days at room temperature to obtain a 0.2 mm interlayer membrane;

Step 2: the interlayer membrane was soaked in toluene for 8 h, the soaked interlayer membrane was transferred to methanol to be soaked for 4 h, and dried for 4 days at room temperature to obtain a modified interlayer membrane; and

Step 3: the modified interlayer membrane was placed in the middle of two layers of glass to perform hot press compound for 5 min at the temperature of 140° C. under the pressure of 0.5 Mpa to obtain the high-strength laminated glass.

Comparative example 3: A preparation method of a laminated glass based on an interlayer membrane. In this comparative example, introduction amounts of a reactive anti-UV agent and starch nanoparticles increased; the preparation method of the laminated glass based on the interlayer membrane specifically comprises the following steps:

Step 1: 18 parts of polytetrahydrofuran ether glycol and 4 parts of reactive anti-UV agent were successively added into N,N-dimethylformamide, 12 parts of diisocyanate and 0.8 part of organotin catalyst were successively added under the atmosphere of nitrogen, the obtained mixture was heated to 85° C. to react for 2 h, vacuum de-bubbling was performed on the above reaction product, a starch dispersing liquid containing 3 parts of starch nanoparticles (3wt % starch nanoparticles, 0.05wt % of photoinitiator benzoin dimethyl ether and the balance of N,N-dimethylformamide) was added into the product subjected to vacuum de-bubbling, the above materials were stirred for 20 min in light illumination under an UV lamp with a light irradiance of 40 mA/cm², 1.8 parts of chain extender (1,4-butanediol and 2,6-pyridine dimethyl alcohol in a mass ratio of 3:2) and 0.5 part of reactive dye were added into the stirred material to be stirred for 20 min, the obtained mixture was poured into a mold and cured for 2 days at 80° C., and the cured product was subjected to standing for 5 days at room temperature to obtain a 0.2 mm interlayer membrane;

Step 2: the interlayer membrane was soaked in toluene for 8 h, the soaked interlayer membrane was transferred to methanol to be soaked for 4 h, and dried for 4 days at room temperature to obtain a modified interlayer membrane; and

Step 3: the modified interlayer membrane was placed in the middle of two layers of glass to perform hot press compound for 5 min at the temperature of 140° C. under the pressure of 0.5 Mpa to obtain the high-strength laminated glass.

Comparative example 4: A preparation method of a laminated glass based on an interlayer membrane. In this comparative example, the interlayer membrane was not modified; the preparation method of the laminated glass based on the interlayer membrane specifically comprises the following steps:

Step 1: 20 parts of polytetrahydrofuran ether glycol and 2 parts of reactive anti-UV agent were successively added into N,N-dimethylformamide, 12 parts of diisocyanate and 0.8 part of organotin catalyst were successively added under the atmosphere of nitrogen, the obtained mixture was heated to 85° C. to react for 2 h, vacuum de-bubbling was performed on the above reaction product, a starch dispersing liquid containing 1.2 parts of starch nanoparticles (1.2wt % starch nanoparticles, 0.05wt % of photoinitiator benzoin dimethyl ether and the balance of N,N-dimethylformamide) was added into the product subjected to vacuum de-bubbling, the above materials were stirred for 20 min in light illumination under an UV lamp with a light irradiance of 40 mA/cm², 1.8 parts of chain extender (1,4-butanediol and 2,6-pyridine dimethyl alcohol in a mass ratio of 3:2) and 0.5 part of reactive dye were added into the stirred material to be stirred for 20 min, the obtained mixture was poured into a mold and cured for 2 days at 80° C., and the cured product was subjected to standing for 5 days at room temperature to obtain a 0.2 mm interlayer membrane;

Step 2: the modified interlayer membrane was placed in the middle of two layers of glass to perform hot press compound for 5 min at the temperature of 140° C. under the pressure of 0.5 Mpa to obtain the high-strength laminated glass.

Performance detection 1: the interlayer membranes prepared in examples and comparative examples were subjected to performance testing; the tensile property referred to GB/T1040.3, and the tensile strength was detected at the rate of 50 mm/min; the adhesive property referred to GB/T33334, and the adhesive strength was tested at the rate of 5 mm/min; the UV irradiation resistance referred to a method in GB15763.1, testing was conducted for 100 h and then the appearance was observed; and the correspondingly obtained high-strength laminated glass was subjected to impact resistance testing, and testing parameters were as follows: ball falling was conducted under the conditions that the mass of the fallen ball was 50 g and the height was 110 cm. The obtained data are seen in Table below.

| | | Comparative | Comparative | Comparative | Comparative |
|---|---|---|---|---|---|
| Samples | Example 1 | example 1 | example 2 | example 3 | example 4 |
| Tensile | 56.5 | 53.4 | 55.2 | 54.6 | 52.4 |
| strength (Mpa) | | | | | |
| Bonding | 4.2 | 3.7 | 3.9 | 3.9 | 3.5 |
| strength (Mpa) | | | | | |
| UV irradiation | No significant | Bubbles | Bubbles | No significant | No significant |
| resistance | discoloring | appear | appear | discoloring | discoloring |
| Ball falling | 9 | 8 | 8 | 8 | 7 |
| frequency | | | | | |

It can be seen from data in the above-mentioned table that in the present application, polyurethane is used as a main body to prepare the interlayer membrane, the high-strength laminated glass having excellent UV resistance and impact resistance is prepared by introducing the reactive anti-UV agent, the nanoparticles and the subsequent solvent treatment.

Finally, it should be noted that the above descriptions are only preferred embodiments of the present disclosure, but are not intended to limit the present disclosure. Although the present disclosure has been described in detail with reference to the above-mentioned embodiments, those skilled in the art still make amendments to the technical solutions described in the above-mentioned embodiments, or conduct equivalent replacement to a part of technical features. Any amendments, equivalent replacements, improvements and the like made within the spirit and principle of the present disclosure should be included within the scope of protection of the present disclosure.

What is claimed is:

1. A preparation method of a high-strength laminated glass based on an interlayer membrane, comprising the following steps:
Step 1: successively adding polytetrahydrofuran ether glycol and an reactive anti-UV agent into N,N-dimethylformamide, successively adding diisocyanate and an organotin catalyst under the atmosphere of nitrogen, heating to 80-85° C. to react for 2-3 h, performing vacuum de-bubbling, adding a starch dispersing liquid containing starch nanoparticles, stirring for 20-30 min under the UV irradiation, adding a chain extender and a reactive dye, stirring for 20-30 min, pouring the obtained mixture into a mold, curing for 1.5-2.5 days at 75-85° C., and performing standing for 4-6 days at room temperature to obtain the interlayer membrane;
Step 2: soaking the interlayer membrane in toluene for 6-10 h, transferring the soaked interlayer membrane to methanol to be soaked for 2-4 h, and drying for 3-5 days at room temperature to obtain a modified interlayer membrane; and
Step 3: placing the modified interlayer membrane in the middle of two layers of glass, and then performing hot press compound to obtain the high-strength laminated glass;
the raw materials of the interlayer membrane comprising the following components in parts by weight: 18-22 parts of polytetrahydrofuran ether glycol, 2-3 parts of reactive anti-UV agent, 11-13 parts of diisocyanate, 0.5-1 part of organotin catalyst, 1-1.5 parts of starch nanoparticles, 1-2 parts of chain extender and 0.5-1 part of reactive dye;
a method for preparing the reactive anti-UV agent comprising the steps of: (1) evenly stirring citric acid, cysteine and deionized water for 2-2.5 h at 75-80° C., transferring the obtained mixture to a blast oven to be dried for 10-12 h at 130-140° C. to obtain pyridone diacid; (2) evenly mixing and stirring pyridone diacid, epichlorohydrin and tetrabutylammonium bromide for 20-30 min at 80-85° C., cooling to 45-50° C., dropwise adding a sodium hydroxide solution, stirring for 20-30 min, heating to 52-55° C. and stirring for 4-6 h to obtain dicyclooxopyridone; and (3) successively adding dicyclooxopyridone and 2-(ethenoxy) ethylamine into toluene to react for 6-8 h at 60-65° C., and then distilling to remove toluene to obtain the reactive anti-UV agent.

2. The preparation method of the high-strength laminated glass based on the interlayer membrane according to claim 1, wherein a mass ratio of the citric acid to the cysteine to the deionized water is 19:(12-15):(10-20); a mass ratio of the pyridone diacid to the epichlorohydrin is 3:(20-22); and a molecular weight ratio of the dicyclooxopyridone to the 2-(ethyleneoxy) ethylamine is 4:(2.8-3).

3. The preparation method of the high-strength laminated glass based on the interlayer membrane according to claim 1, wherein the starch dispersing liquid comprises the following raw materials: 1-1.5wt % of starch nanoparticles, 0.05-0.08wt % of photoinitiator and the balance of N,N-dimethylformamide.

4. The preparation method of the high-strength laminated glass based on the interlayer membrane according to claim 1, wherein a method for preparing the starch nanoparticles comprises: (1) evenly mixing thioglycolic acid, acetic anhydride and corn starch, adding sulfuric acid, stirring and reacting for 12-16 h at room temperature, washing and drying to obtain thiolated starch; (2) successively dispersing corn starch and thiolated starch that are in mass ratio of 4:1 into the deionized water to obtain a solution with a solid content of 5-6wt %, stirring the above solution for 1-1.5 h at 90-92° C., performing ultrasonic treatment for 10-15 min under the power of 550-600 W, centrifuging and sucking supernatant; and (3) performing ultrasonic treatment on the supernatant in an ice bath under the power of 550-600 W, transferring the supernatant subjected to ultrasonic treatment to absolute ethyl alcohol at the rate of 2-5 mL/min, centrifuging and drying to obtain the starch nanoparticles.

5. The preparation method of the high-strength laminated glass based on the interlayer membrane according to claim 1, wherein the chain extender comprises 1,4-butanediol and 2,6-pyridine dimethyl alcohol in a mass ratio of 3:2.

6. The preparation method of the high-strength laminated glass based on the interlayer membrane according to claim 1, wherein the process condition for the UV irradiation is as follows: the light irradiance is 20-50 mW/cm².

7. The preparation method of the high-strength laminated glass based on the interlayer membrane according to claim 1, wherein the temperature of the hot press compound is 120-140° C., the pressure of the hot press compound is 0.4-0.6 Mpa, and the time of the hot press compound is 3-8 min.

8. High-strength laminated glass prepared by using the preparation method of the high-strength laminated glass based on the interlayer membrane according to claim 1, wherein the thickness of the interlayer membrane in the high-strength laminated glass is 0.2±0.05 mm.

9. High-strength laminated glass prepared by using the preparation method of the high-strength laminated glass based on the interlayer membrane according to claim 2, wherein the thickness of the interlayer membrane in the high-strength laminated glass is 0.2±0.05 mm.

10. High-strength laminated glass prepared by using the preparation method of the high-strength laminated glass based on the interlayer membrane according to claim 3, wherein the thickness of the interlayer membrane in the high-strength laminated glass is 0.2±0.05 mm.

11. High-strength laminated glass prepared by using the preparation method of the high-strength laminated glass based on the interlayer membrane according to claim 4, wherein the thickness of the interlayer membrane in the high-strength laminated glass is 0.2±0.05 mm.

12. High-strength laminated glass prepared by using the preparation method of the high-strength laminated glass based on the interlayer membrane according to claim 5, wherein the thickness of the interlayer membrane in the high-strength laminated glass is 0.2±0.05 mm.

13. High-strength laminated glass prepared by using the preparation method of the high-strength laminated glass based on the interlayer membrane according to claim 6, wherein the thickness of the interlayer membrane in the high-strength laminated glass is 0.2±0.05 mm.

14. High-strength laminated glass prepared by using the preparation method of the high-strength laminated glass based on the interlayer membrane according to claim 7, wherein the thickness of the interlayer membrane in the high-strength laminated glass is 0.2±0.05 mm.
